(19) United States
(12) Patent Application Publication
(10) Pub. No.: US 2016/0267505 A1
(43) Pub. Date: Sep. 15, 2016

(54) Web-Based Online Customer Experience and Survey Management and Monitoring System

(71) Applicant: Gale Force Digital Technologies, Inc., Palm Beach Gardens, FL (US)

(72) Inventor: Terence J. Murphy, Palm Beach Gardens, FL (US)

(21) Appl. No.: 15/067,247

(22) Filed: Mar. 11, 2016

Related U.S. Application Data
(60) Provisional application No. 62/131,875, filed on Mar. 12, 2015.

(51) Int. Cl. G06Q 30/02

(52) U.S. Cl. CPC G06Q 30/0203; G06Q 30/0282

(57) ABSTRACT

A web-based online customer experience and survey management and monitoring system to provide business owners with tools to monitor opinions on different websites, solicit opinions from existing customers, and manage negative customer experiences through various alert systems and response options. In addition, there is a suite of reporting available to business owners based on survey metrics, geographic locating and competitive analytics.

### PRIORITY CLAIM

In accordance with 37 C.F.R. 1.76, a claim of priority is included in an Application Data Sheet filed concurrently herewith. Accordingly, the present invention claims priority to U.S. Provisional Patent Application No. 62/131,875, entitled “WEB-BASED ONLINE CUSTOMER EXPERIENCE AND SURVEY MANAGEMENT AND MONITORING SYSTEM”, filed Mar. 12, 2015. The contents of the above referenced application is incorporated herein by reference.

### FIELD OF THE INVENTION

This invention is related to the field of online customer experience and survey management.

### SUMMARY OF THE INVENTION

The system is composed of a number of different features that provide business owners with tools to monitor their ratings/reviews on different websites, solicit feedback from existing customers, automatically post positive feedback and manage negative customer experiences through various alert systems and response options. In addition, there is a suite of reporting available to business owners based on 3^{rd} party and internal review metrics, geographic locating, and competitive analytics.

An objective of the invention is to provide real-time monitoring of business owners' ratings on websites and provide reporting on incoming reviews, both through the system and on third party review sites, in real time.

Another objective of the invention is to provide sentiment analysis which allows the business owner to define the threshold that separates a positive experience from a negative experience and then automatically prompt customers who submit positive reviews to publish their reviews to third-party review sites. On the other hand, when a customer submits a negative review they are not prompted to publish it and it is routed to the business owner to help improve their business. It will be possible to customize messaging specific to each different star rating.

Still another objective of the invention is to provide use of the sentiment analysis and the ability to customize response pages based on either a positive/negative customer experience or by the rating/number of stars (1-5). Customers leaving reviews are automatically routed to pages with different messaging and calls to action. Happy customers are asked to leave reviews on third-party websites (defined by the business owner) with direct links and automatic copying of the review text, while unhappy customers are instead asked to provide feedback on how the business could serve them better.

Still another objective of the invention is to provide real-time notifications. The owner has the option of setting notifications to team members by email, SMS or both. When a review is received, positive or negative, the emails and phone numbers added into the settings will receive a notification telling the owner that a new review has been generated. The subscriber can also create groups that will receive only positive or negative reviews and customize the notification messaging.

A further objective of the invention is to provide employee ratings wherein entries can be added by employee, department, location, etc. This allows the business owner to generate reports in the dashboard by employee, department, location, etc., in order to see which employees or areas of the company are best serving customers. The reporting also allows them to see which specific reviews are tied to each employee or area of the company so that the content of the reviews can be used for further insight and improvement of the customer experience.

Another objective of the invention is to provide review fraud detection wherein each time a review is left in the system, the IP address of the reviewer is logged. If the system detects multiple reviews from the same IP address, it triggers an alert to the business owner that someone is submitting multiple reviews. The fraud detection goes one step further by using geo-locating to show a business owner the source of multiple reviews to help determine if it is a competitor, disgruntled employee, upset customer and the like.

Still another objective of the invention is to provide a competitive analysis tool wherein business owners can set up monitoring on specific competitors to see their average ratings by site and number of reviews. They can also set up important keywords to track review content to see if their competitors are receiving reviews for specific products, services, etc. Finally, they can also view the most frequently used keywords in their competitors' reviews to receive insight into what their competitors are doing right or wrong.

Yet another objective of the invention is to provide geographic heat mapping. Using the same geo-locating technology in the fraud detection, a business owner can view a local, regional or national map that uses color shading in order to indicate from which geographic areas the most reviews are received. They can also view this map by average rating to see where the best/worst reviews are generated.

Still yet another objective of the invention is to provide benchmarking wherein business owners can view the average ratings/number of reviews by their vertical and/or their geographic area to see how they stack up in the overall landscape.

Other objectives, advantages and benefits associated with this invention will be apparent to those knowledgeable from the description, examples and claims which follow.

### BRIEF DESCRIPTION OF THE DRAWINGS

FIG. 1 is flow diagram of a solicitation e-mail request;

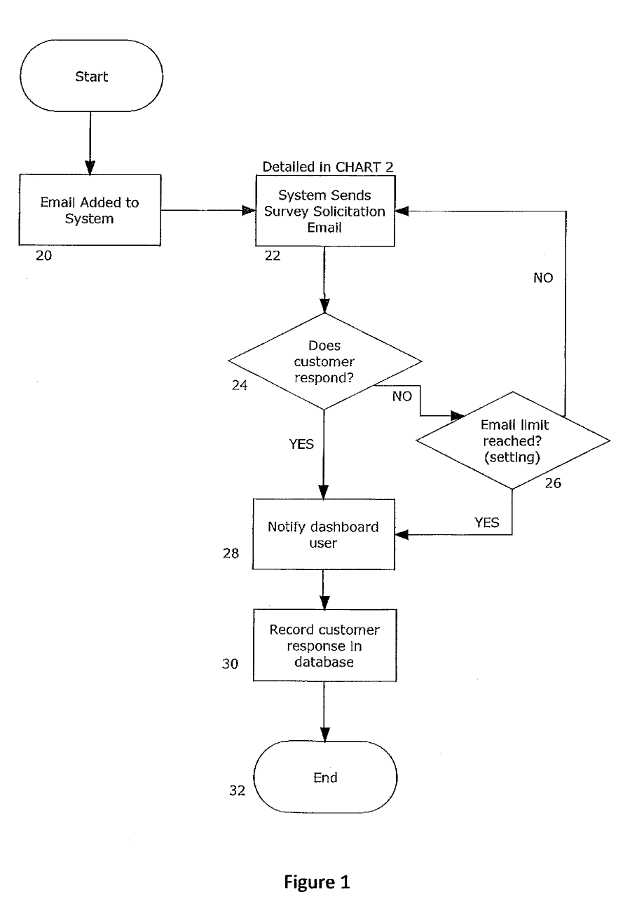

FIG. 2 is flow diagram of solicitation steps;

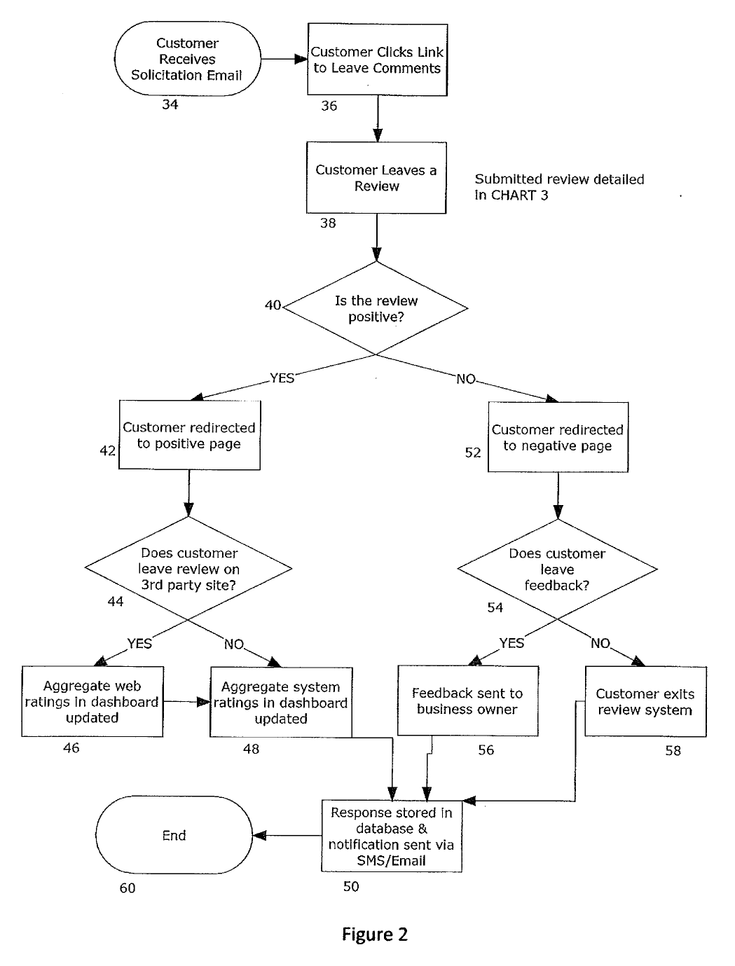

FIG. 3 is a flow diagram of a review submission; and

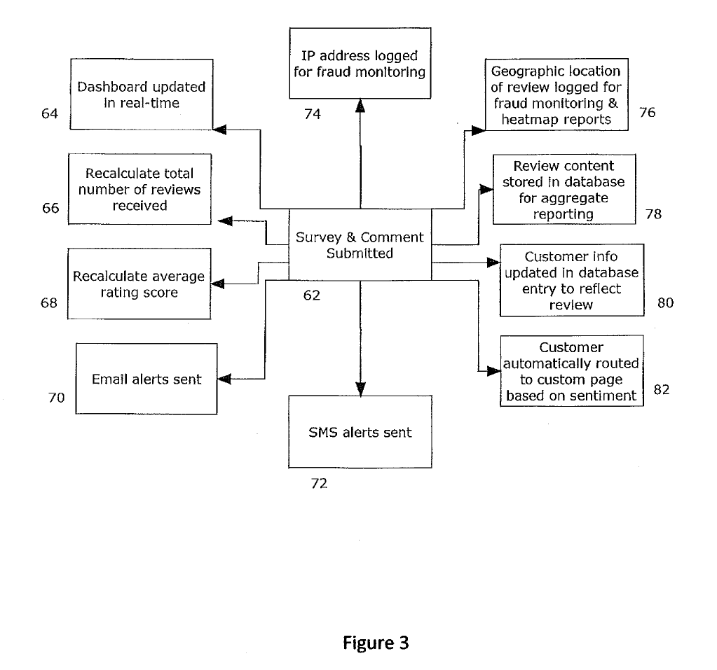

FIG. 4 is a flow diagram of a kiosk embodiment.

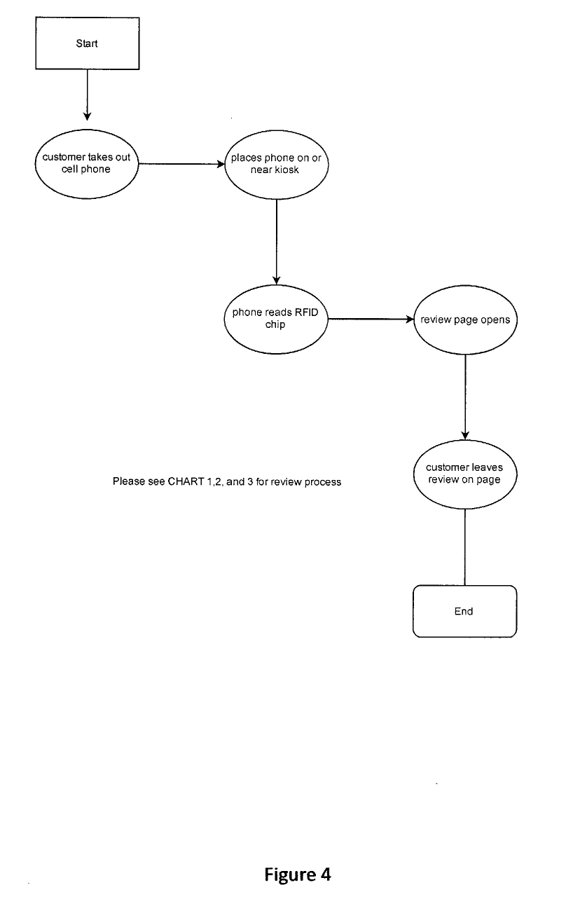

### DETAILED DESCRIPTION OF THE PREFERRED EMBODIMENT

Detailed embodiments of the instant invention are disclosed herein; however, it is to be understood that the disclosed embodiments are merely exemplary of the invention, which may be embodied in various forms. Therefore, specific functional and structural details disclosed herein are not to be interpreted as limiting, but merely as a basis for the claims and as a representation basis for teaching one skilled in the skill to variously employ the present invention in virtually any appropriately detailed structure.

The platform provides an online customer experience and survey management monitoring system directed to five user types: administrator, partner, reseller, subscriber, employee, multi-location manager.

Administrator (Admin) can add subscribers, multi-location managers and reseller users. An Admin panel allows for management of all reseller and subscriber users in a logical format with easy-to-access information including: business, name of the subscriber/reseller, contact email address, average scores, the number of results received, the last log-in and the number of emails added to the review queue. The admin users can also set a notification for a specified number of days since last login and/or last time a subscriber added email addresses to the system.

The second highest level on the platform would be partner. This would include all functionality without the ability to sell the invention to other partner-level distributors. The advantage of this level would be for the distribution of the invention to resellers.

System Administrator is Client's full administrative access level to all settings and functionality as owners of the software. The system administrator has exclusive access to all user accounts, including subscriber accounts added by resellers, and has the ability to override any other user, add and suspend other users, etc.

Reseller has similar administrative access but only as it pertains to their subscribers. They are able to white label their dashboard so that their clientele will see their branding upon logging into the system. They have the ability to add custom formatting using CSS to change their dashboard's colors/styles.

Subscriber is the user level for the primary customer type of the system. A subscriber logs in to access the reputation monitoring and management tools, whereas system administrators and resellers are logging in to change global settings and add new subscribers. Subscribers may add and edit customer and employee, information, input the URLs of review site profiles into the platform and add/remove additional review sites.

Employee is a sub-user of a subscriber. Employees have limited access to the system. They are able to add new customers to the review system, monitor/respond to reviews, etc., but are not able to delete or change important business settings like the business address or the URL that defines the business' page on a review site.

Multi-Location Manager is a user type that has all the same access and editing rights as a subscriber, but is assigned to someone who is responsible for managing a multi-location business. For example, if a company has 20 locations, each location would have a subscriber level user; however, all 20 locations could be grouped under the multi-location manager user so that this user could check the status of the various locations. The multi-location manager has the ability to assign the subscriber status of each location to other users (i.e., store manager), and the subscribers of each location can assign employee-level users (i.e., customer service manager).

The system allows resellers to add their own segmented subscribers and multi-location manager users (viewable in a logical format at the admin level, sortable/dropdown).

A simplified CRM system is used to manage customers and add them to the review queue. A micro-site uses subscriber information and reviews to construct a page that looks like a directory site.

The system emails each customer in the email queue based on the subscriber's options. The options include the number of times and frequency a customer is emailed and the message to be sent. (number of times, days between tries, varying messages). The emails are 100% editable, including content, header information, sender address, subject, signature, etc., with standard text editing features, such as choice of font, bold, italic, underline, spacing (similar to the “format text” option in Outlook). Customers leave reviews which could be positive or negative.

A subscriber sets the review threshold in options. Positive experiences are published to the micro-site and to a universal website plugin that places the comments on the subscriber's website. Customers who leave positive reviews are directed through an algorithm to a different page than those who leave a negative review. The content on these two pages is also completely customizable allowing for specific messaging such as a “thank you” or an apology. The subscriber can choose to direct customers to the different two different positive and negative pages based upon threshold or exact rating level.

Thank you pages and emails are customizable based on the star rating the user gives, not just one negative set and one positive set. Positive reviewers are encouraged to post reviews to their profiles on major review sites.

The system allows for robust white-labeling options for resellers and dashboard reporting on key metrics based on number of reviews, average rating, breakdown by review site, percent of emailed customers completing reviews, percent of customers completing reviews leaving positive/negative, etc., presented in graphical format (where possible) such as pie charts, line graphs, bar graphs, and the like.

Reporting for subscribers is broken down by employee so that business owners can see which employees are getting good ratings and which ones are getting poor ratings. The system has the ability to export reports in common format(s): CSV, PDF, XLS and the like. There will also be an API to export to reports to other platforms. The system has the ability for the user to add review soliciting for any review site by specifying URL and logo.

The system is able to automatically post positive results to Facebook, Twitter, Google and any other selected sites with an API. Options are available to the subscriber to turn this on/off and to limit how many results to post. Also, it has the ability to manually publish any comments with a click in the dashboard.

The system has the ability for a subscriber to preview any pages they are making customizations to via a WYSIWYG editor (e.g. thank you page or a review feedback page). The subscriber can customize the consumer sites that appear on the dashboard based on what consumer sites are most important to them.

The user can import contacts from SalesForce, Constant Contact, MailChimp, and QuickBooks. Import from any other CRM via a standard CSV file is also possible.

The system automatically reminds administrators and resellers by email if a client has not uploaded email addresses within a certain period of time, which can be determined by admins/resellers in their options.

Subscribers can add, delete and rearrange the order of the consumer sites they are asking customers to post reviews on. The system has the ability for admin and resellers to customize and white label the 404 error page.

Part of the reporting is a “Visibility Report” that matches the subscriber's information (i.e., company name, address, phone number, web URL, etc.) in the platform against various sites and directories on the Internet. The purpose of this report is to tell subscribers what percentage of directory and review websites have 100% matching information, partially matching information and no information found at all. (For example, if a subscriber only added three review websites to its account and one had the subscriber's business information 100% correct, one contained some errors, and one had no match at all, then the visibility report would say that 33% of sites have correct info, 33% have partial info and 33% no info.)

With geographic heatmapping using the same geo-locating technology in the fraud detection, a business owner can view a local, regional, or national map that uses color shading in order to indicate which geographic areas generate the most reviews. They can also view this map by average rating to see where the best/worst reviews come from. Geographic heatmaps illustrate a map overlaid with the geographic source of a business' reviews. The locations of reviewers would contribute to areas on the map being color coded red, orange, yellow, and gray based on the number of reviews coming from that location. Red would indicate the “hottest” geographic areas while gray would indicate the “coldest” areas on the map (no reviews). The map preferably adjusts dynamically to the geographic area it uses based on the business owner's settings. For instance, a national business would want to see a national map by default, with geographic areas defined by DMA. Local businesses would want to see a local map of their state/county with geographic areas defined by city. The ability to zoom in/out will be included and automatically adjust how large of a geographic area to group reviews in.

As previously stated, another objective of the invention is to provide a competitive analysis tool wherein business owners can set up monitoring on specific competitors to see their average ratings by site and number of reviews. Initially, the most efficient way for this to work would be to preset a number of review sites that this tool uses. For instance, it looks at some well-known generic and perhaps some other industry-specific review websites. This allows the business owner to use simple checkboxes to enable/disable tracking of review sites by competitor. Limitations are important so people don't use this as a way around adding another business account to the platform. It will not allow a user to enable/disable tracking of “core” review sites, those considered major sites, just add on to them. Another important limitation is what information to report. The feature will report an average rating across all selected review sites, average rating on each of the selected sites, total reviews across all and total reviews by site.

The invention allows the ability to request customer satisfaction surveys from customers/clients by integrating the ability to send text messages with the purpose of soliciting a review. Phone numbers can be added three ways: A user manually enters phone a number, a customer manually texts a code to #####, or the customer scans a QR code with a smartphone which then automatically texts code. QR codes can be generated in a platform so that separate QR codes can be made for individual employees. If this feature is not needed, a single QR code could be generated for a single SMS review-soliciting campaign. Once a customer opts in, they will receive a link directly to a survey page. The subscriber will be able to decide if those customers receive the same survey form the others get via email, or set up a different one so extra fields (email, name, etc.)can be added.

The system can be made capable to use geographic tracking in browsers to actually determine where reviews are coming from, rather than user-provided data. IP Address Logging can be used to help business owners discover review fraud, add alerts in for review fraud, and obtain the name of ISP base for reporting.

The invention monitors major and specialized review websites with aggregate score reporting at an individual website level and an overall level, as well as the ability to view the text of all reviews on select sites. The subscriber can customize which review sites show up in the subscriber's dashboard, both manually and by selecting default business categories/groups. For example, the category of “restaurant” could be set to show sites important to restaurants by default, while the category of “store” wouldn't include such specialized sites, as they only pertain to restaurants. These act almost like templates to suggest review sites to track, but the subscriber is still able to add/remove individual sites.

The invention will have templates for companies in industries that are frequently reviewed, such as hospitality, automotive, consumer goods and medical services. A subscriber utilizing such a template will have access to pre-written review requests and applicable questions with industry-specific terms. For example, a restaurant using the restaurant industry template could select “How was your waiter?” from a list of default questions.

A separate website (micro-site) will collect and display all positive reviews posted through this platform. The subscriber determines what rating constitutes a positive review, and none of the negative reviews are displayed on the micro-site. Each contracted business will have a page on the site which will include the business name, address, phone number, hours, a map with pin of the location, payments accepted, description and business categories. The ability to add more custom fields by the administrator will be included. Having all the reviews on one site offers significant reporting options, such as counts/metrics of emails sent, reviews left, etc. These reports will be composed of easy-to-understand graphs and charts. The ability to export the reports will also be included.

The system is a template system or can use standard cascading style sheets (CSS) so that the look/feel of the front end can be easily modified. Resellers will have a textbox in order to edit custom files that would take precedence over default styles for their dashboards and the subscribers they manage.

Functionality of Review Solicitation. A basic CRM system where customer names, addresses, phone numbers, emails and notes can be entered. This system would make up the core of the review solicitation system. Customers can be added either one at a time or bulk uploaded in a CSV format (both required, subscriber chooses how to add their customers). Inside of the dashboard, there is a sortable list (with filters) of the entire customer database, including the number of stars (review/rating) they left and if they have been solicited for a review. Upon adding a customer there is an option (checkbox) to solicit a survey response. The subscriber could either do this while adding the customer or from the dashboard list.

Once a customer is added, there is an optional dropdown (or field in the case of bulk upload) where an employee's name can be selected. This will tag the eventual customer review with the employee that served them. This allows the subscriber to filter surveys by employee and generate reports to evaluate employee performance. When customers are solicited to participate in a survey, they will receive an email, with customizable content, that directs them to a survey page asking for an opinion from 1 to 5 stars and a comment. Employee names will also be in a field that could be edited but will normally be filled in by default using the data in the CRM. The survey management system saves these results in a database, along with a date/timestamp. On the dashboard where the major survey site information is shown, the subscriber can also see an aggregate rating as compiled by the system and the latest review text.

Functionality of Publishing Survey Results. Utilizing the database of solicited surveys, the results are published on a subscriber's micro page. The subscriber has the option to select a star level threshold at which opinions are published. For example, if a subscriber chooses a minimum survey level of 3, only individuals who left a rating of 3 stars or more would be published. This is how the subscriber defines a positive vs. negative result and would affect additional functionality listed below. The subscriber has the ability to add/remove opinions from the micro page on a case-by-case basis. The opinions that are chosen to be published could also be added to the subscriber's website via a basic WordPress plugin. The plugin functionality will output the number of review stars, the name of the reviewer, the text of the review and the latest 10 reviews (with pagination so someone could view older reviews). The default of this plugin will have some basic CSS styling and graphics for stars so that it could be added directly to a WordPress page via WordPress shortcode (e.g. [list-reviews]). The inclusion of attributes in the shortcode is not necessary but would make for favorable extra functionality. For example, the subscriber could use the shortcode [list-reviewslimit=“20” pages=“5”] to show a maximum of 20 reviews per page, and a maximum of 5 pages. For subscribers who do not have a WordPress website, the subscriber can add results to their websites using a simple script that such subscribers can place on their websites such as Javascript or a PHP include like: <?php include‘http://www.ourwebsite.com/dir/script.php’; ?> In the above example, the client would have to have at least one PHP page.

Interaction with Major Consumer Sites. A customer leaving a positive response is routed to a page thanking them for their comments. The content is customizable but also includes a way for customers to share their comments on major consumer sites. If a site has an API by which comments can be published, then that would be the logical way for comments to be added. However, most consumer sites require an account and for someone to log in before they can leave comments about a business. For example, Google is a very prominent review aggregator, and people need to log in to post reviews. Subscribers will also be able to configure the invention to automatically post user reviews to their accounts, such as Google+ and Facebook.

Customers leaving negative comments are not prompted to post it on a major site. These customers are directed to a different page. Subscribers are able to customize this page to create a strategy to best remedy poor customer experiences. They may choose to offer a simple apology via the written word or a video and/or include a coupon code. Subscribers have the option to receive alerts via the dashboard, email and SMS if they get a positive or negative customer response (both through the solicitation system and on a major site).

The subscriber is able to designate a different message for each level of rating. For example, while a four and five-star rating might hit the threshold for a positive review, the business owner might want a customer leaving a four-star review to see a different message/landing page than a customer leaving a five-star review. This functionality will also extend to the automatic emails that are sent.

Further embodiments include a reply to reviews wherein the user already has the ability to click a review and go straight to it on a third party site. This addition simply adds a button/link that very clearly spells out “Reply to Review” so that it reminds business owners that they can engage with customers leaving comments. Notification through API is a way for resellers to obtain data in the dashboard. This will allow for strategic partnerships and the API will not be publicly available. The API allows a user to pull our raw data into their system and present it on their dashboard (or combine it with their data to draw additional conclusions, like ROI) so that they can custom tailor data to their sub-users. Emails can be uploaded via API to allow for their customers to submit emails directly to the system from their dashboard. A front-end scan can create another instance of a review tool for salespeople to use where they can plug a business in and get an algorithm-derived score for its online reputation. Reports generated by the front-end scan include examples of reviews (positive and negative) and a breakdown of reviews by important sites (e.g. Google, etc.).

Benchmarking and Keyword Search. The system will provide benchmarking data by aggregating information including business industry/vertical, geographic location, total number of surveys returned, number of reviews by site, average survey score, average review score by site, etc. Benchmarking data is used to determine average performance levels so that a business' feedback can be compared to that of similar businesses. In addition, the content of individual surveys will be stored and indexed so that a user can search all their reviews for specific keywords in the title and/or comment fields. The combination of these features allows for benchmarking of performance and identification of the customers' experiences.

Expanded Competitive Analysis permits the insertion of certain names of businesses and track them against the user's business. Competitive Keyword Intel tracks competitors by both name of business and keywords. Example walkthrough: Local taco restaurant sets up alerts for other companies that they define as being competitors. They also add the keyword “taco sauce” as being an important keyword in their competitive analysis/monitoring. Alternatively, the tool lists the top keywords used in review content. This allows the restaurant to see which of its competitors are doing well because everyone loves their particular sauce, so the restaurant knows to run a special to bring customers in to try its sauce.

Chart 1 is a flow diagram of a solicitation email request comprising the steps of adding an email (20) to the system. The system sends the survey/solicitation (22) to a customer (24). A decision is made based upon whether the customer fails to respond or whether an email limit is reached (26). If the customer does respond, the dashboard user is notified (28) and the customer recorded in a database (30) and the steps are completed (32).

Subscribers are able to search their reviews for keywords in order to parse through data quickly, looking for important information and trends. Reviews containing the keyword(s) would be aggregated, and the keywords themselves bolded for easy visibility. This gives subscribers insight into how and in what context their products/services are being referred to by customers.

A ‘hot words’ functionality is also available on the dashboard to provide a visual representation of word frequency in reviews. Hot words are the most commonly used words in reviews, and the size of the words within a word cloud would be contingent upon their relative frequency of use. For varying scope, the number of hot words to display could be adjusted by the subscriber.

Chart 2 is a flow diagram of solicitation steps involving the customer receiving a solicitation email (34). The customer clicks a link (36) for leaving a review (38). An automated response algorithm then determines if the review is positive or negative (40). If the review is positive, the customer is redirected to a positive page (42) and it is determined if the customer leaves a review on a third party website (44). The ratings on a dashboard are updated if a review is left (46) or if no review is left (48). The response is stored in a database (50) and the notification forwarded. If the review is negative, the customer is redirected to a different page (52), and it is determined if the customer leaves feedback (54). If feedback is provided, the business owner is notified (56), or if no review is left, the customer exits the system (58). The response is stored in a database (50) and a notification forwarded ending the steps (60).

Chart 3 is a flow diagram of a review submission illustrating the simultaneous processes that occur once a survey and comments are submitted (62) including the steps of updating the dashboard (64), recalculating the total number of reviews (66), recalculating the average rating score (68), and sending email alerts (70). Further, the SMS alerts are sent (72), and the IP address is logged for fraud monitoring (74). The geographic location of the review is logged (76), the review content is stored in a database (78), customer information is updated in the database to reflect the review (80), and the customer is automatically routed to custom page based on sentiment (82).

One skilled in the field will readily appreciate that the present invention is well adapted to carry out the objectives and obtain the ends and advantages mentioned, as well as those inherent therein. The embodiments, methods, procedures and techniques described herein are presently representative of the preferred embodiments, are intended to be exemplary and are not intended as limitations on the scope. Changes therein and other uses will occur to those skilled in the field which are encompassed within the spirit of the invention and are defined by the scope of the appended claims. Although the invention has been described in connection with specific preferred embodiments, it should be understood that the invention as claimed should not be unduly limited to such specific embodiments. Indeed, various modifications of the described modes for carrying out the invention which are obvious to those skilled in the field are intended to be within the scope of the following claims.

what is claimed is:

1. A web-based online customer experience and survey management and monitoring system comprising the steps of:
monitoring a business website accessible on a computer device coupled to an internet to detect the ratings and reviews of the business;
determining, by a computer device coupled to the internet, if a tenor of said ratings and review is negative or positive;
managing a negative tenor by a computer device coupled to the internet through alert and response options; and
managing a positive tenor by a computer device coupled to the internet by updating a dashboard.

2. The web-based online customer experience and survey management and monitoring system according to claim 1 including the step of soliciting survey and comments from the business's existing customers.

3. The web-based online customer experience and survey management and monitoring system according to claim 1 including the step of providing said review and response to the business and storing said responses.

4. The web-based online customer experience and survey management and monitoring system according to claim 1 wherein said review is based upon review metrics.

5. The web-based online customer experience and survey management and monitoring system according to claim 1 wherein said review is based upon geographic locating.

6. The web-based online customer experience and survey management and monitoring system according to claim 1 wherein said review is based upon competitive analytics.

7. The web-based online customer experience and survey management and monitoring system according to claim 1 including the step of providing word clouds of words written in reviews.

8. The web-based online customer experience and survey management and monitoring system according to claim 1 including the step of tracking reviews by employee.

9. The web-based online customer experience and survey management and monitoring system according to claim 1 including the step of contact relationship management software integration.

10. The web-based online customer experience and survey management and monitoring system according to claim 1 including the step of geographic heatmapping.

11. The web-based online customer experience and survey management and monitoring system according to claim 1 including a radio frequency identification (RFID) apparatus for review input on site.

12. The web-based online customer experience and survey management and monitoring system according to claim 1 including the step of posting positive online reviews to a separate micro-site.
